(19) United States
(12) Patent Application Publication
(10) Pub. No.: US 2006/0082614 A1
(43) Pub. Date: Apr. 20, 2006

(54) Fluid injection devices and methods for controlling injection quality thereof

(75) Inventors: Chung-Cheng Chou, Taoyuan County (TW); Tsung-Wei Huang, Taipei City (TW); Shang-Shi Wu, Chiai (TW); Tsung-Ping Hsu, Taoyuan (TW)

Correspondence Address: BIRCH STEWART KOLASCH & BIRCH, PO BOX 747, FALLS CHURCH, VA, 22040-0747, US

(73) Assignee: BENQ CORPORATION

(21) Appl. No.: 11/248,172

(22) Filed: Oct. 13, 2005

(30) Foreign Application Priority Data
Oct. 15, 2004 (TW) 93131299

(51) Int. Cl. B41J 2/05

(52) U.S. Cl. 347/56

(57) ABSTRACT

Fluid injectors and methods of controlling injection quality for fluid injectors. The fluid injector comprises a fluid chamber for receiving fluid with a first layer thereon, at least one fluid actuator positioned on the first layer, a sensor for measuring the thickness of the first layer, a second layer disposed on the first layer covering the at least one fluid actuator and the sensor, and a nozzle adjacent to the fluid actuator and communicating with the fluid chamber through the second layer and the first layer. By measuring the thickness of the structural layer and comparing the thickness with a predetermined data bank, an optimized driving signal is provided to inject optimized droplet, thereby improving printing quality.

### BACKGROUND

The invention relates to fluid injection devices, and more particularly, to fluid injection devices and methods for improving injection performance by adjusting output parameters according to efficiency of each fluid injector device.

Typically, fluid injectors are employed in inkjet printers, fuel injectors, biomedical chips and other devices. Among inkjet printers presently known and used, injection by thermally driven bubbles has been most successful due to reliability, simplicity and relatively low cost.

FIG. 1 is a cross section of a conventional monolithic fluid injector 1 disclosed in U.S. Pat. No. 6,102,530, the entirety of which is hereby incorporated by reference. A structural layer 12 is formed on a silicon substrate 10. A fluid chamber 14 is formed between the silicon substrate 10 and the structural layer 12 to receive fluid 26. A first heater 20 and a second heater 22 are disposed on the structural layer 12. The first heater 20 generates a first bubble 30 in the chamber 14, and the second heater 22 generates a second bubble 32 in the chamber 14 to inject the fluid 26 from the chamber 14.

The conventional monolithic fluid injector 1 using bubbles as a virtual valve is advantageous due to reliability, high performance, high nozzle density and low heat loss. As inkjet chambers are integrated in a monolithic silicon wafer and arranged in a tight array to provide high device spatial resolution, no additional nozzle plate is needed.

Structural layer 12 for conventional monolithic fluid injector 1, however, is made of low stress nitride. Besides sustaining heaters, the structural layer 12 is also used as an etching resistive layer for HF solution during the fabrication process. Therefore, thickness and physical characteristics of the structural layer 12 directly affects injection quality and production yield.

Conventionally, the thickness of the structural layer is measured by optical instruments such as an ellipsometer during fabrication. Optical instruments, however, can only measure several specific points on wafer, and measurement of each injector device on a wafer during fabrication. Therefore a simplified method for measuring the thickness of the structural layer for each injector device is desirable.

### SUMMARY

Fluid injector devices integrated with sensors and methods for controlling injection quality thereof are provided. Thickness of the structural layer of fluid injector is measured to precisely control thickness uniformity and improve printing performance.

Accordingly, the invention provides a fluid injection device, comprising a fluid chamber for receiving fluid with a first layer thereon, at least one fluid actuator positioned on the first layer, a sensor for measuring the thickness of the first layer, a second layer disposed on the first layer covering the at least one fluid actuator and the sensor, and a nozzle adjacent to the fluid actuator and communicating with the fluid chamber through the second layer and the first layer.

Note that the fluid injection device can further comprise an analog to digital (A/D) converter connecting the sensor, the A/D converter converting an analog signal from the sensor measuring the thickness of the first layer into a digital signal, a comparator comparing the digital signal with a built-in database, thereby outputting an adjusted signal, and a controller for driving the at least one fluid actuator according to the adjusted signal.

The invention also provides a method of controlling injection quality for a fluid injector. The fluid injector comprises a structural layer and at least one fluid actuator, and a sensor on the structural layer. The method comprises measuring physical properties of the structural layer by the sensor, thereby outputting a control signal; and receiving the control signal to drive the at least one fluid actuator.

### DESCRIPTION OF THE DRAWINGS

The invention can be more fully understood by reading the subsequent detailed description in conjunction with the examples and references made to the accompanying drawings, wherein:

FIG. 1 is a cross section of a conventional monolithic fluid injector;

FIG. 2A is cross section of a fluid injection device according to an exemplary embodiment of the invention;

FIG. 2B is schematic partial view of a sensor of the fluid injector of FIG. 2A;

FIG. 2C is an equivalent R-C series circuit of the sensor of FIG. 2B;

FIG. 3 is a curve showing the relationship between output voltage and thickness of the structural layer of equivalent R-C series circuits;

FIGS. 4A-4C are schematic views of exemplary embodiments of the capacitors of the injection device shown in FIG. 2A;

FIGS. 5A-5C are schematic views of embodiments of the capacitors of the injection device shown in FIG. 2A; and

FIG. 6 is a block diagram of an exemplary embodiment of a fluid injection device according to the invention.

### DETAILED DESCRIPTION

The invention is directed to injector devices and methods of controlling injection quality for fluid injectors. Measuring the thickness of the structural layer of each fluid injecting device by a sensor is provided to ensure the thickness of structural layer within a predetermined range, thereby improving production yield during an etching process. Furthermore, by comparing the measured thickness of the structural layer with a built-in database, an output signal for driving the fluid injection device is adjusted, thus improving injection quality.

Reference will now be made in detail to the preferred embodiments of fluid injectors integrated with a sensor and methods of controlling injection quality for fluid injectors, an example of which is illustrated in the accompanying drawings. The invention may, however, be embodied in many different forms and should not be construed as limited to the embodiments set forth herein

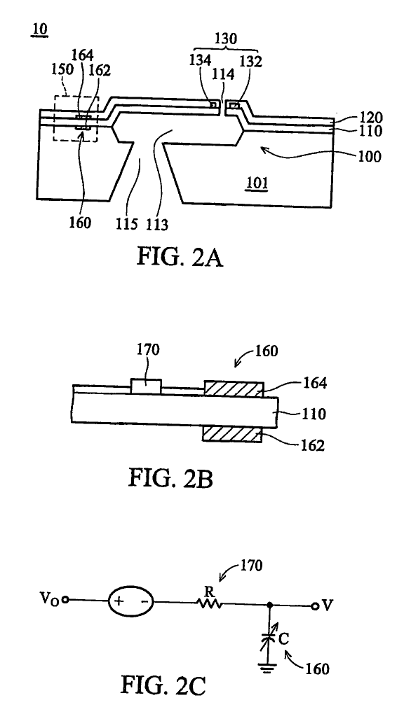

FIG. 2A is cross section of a fluid injection device according to an exemplary embodiment of the invention. Referring to FIG. 2A, a fluid injection device 10 comprises a base 100 with a silicon substrate 101, a structural layer 110, a fluid chamber 113, a channel 115 and/or a manifold. The structural layer 110 is disposed on the silicon substrate 101. The fluid chamber 113 is formed between the silicon substrate 101 and the structural layer 110. The channel 115 is communicated with the fluid chamber 113. At least one fluid actuator 130 is disposed on the structural layer 110 opposing the fluid chamber 113. A sensor 150 is disposed on the base 100 to measure the thickness of the structural layer 110. A passivation layer 120 is formed on the structural layer 110 covering the fluid actuator 130 and sensor 150. A nozzle 114 is created adjacent to the fluid actuator 130 and through the passivation layer 120 and the structural layer 110 and communicating with the fluid chamber 113.

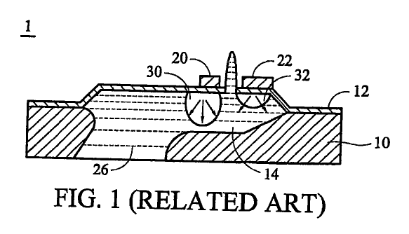

The fluid actuator 130 comprises a thermal bubble generator or a piezoelectric thin film actuator. In an exemplary embodiment, the fluid actuator 130 preferably comprises thermal bubble generators composed of resistive layer. The thermal bubble generator is disposed near the nozzle 114 and outside the chamber 113 of the base 100. The thermal bubble generator 130 includes a first heater 134 and a second heater 132. Like the heaters shown in FIG. 1, the first heater 134 generates a first bubble in the chamber 113, and the second heater 132 generates a second bubble in the chamber 113 to eject fluid from the chamber 113.

Furthermore, the fluid injection device 10 may comprise a signal transmitting circuit (not shown) between the structural layer 110 and the passivation layer 120 communicating with the resist layer 130. The signal transmitting circuit is preferably a patterned conductive layer, such as Al, Cu, or Al—Cu alloy, deposited using PVD, such as evaporation, sputtering, or reactive sputtering on the structural layer 110.

The sensor 150 comprises a resistor 170 and at least one capacitor 160 in series to form an R-C circuit. The sensor 150 is disposed on the base 100 coupling to the structural layer 110 for measuring the thickness of the structural layer 110.

The passivation layer 120, such as silicon oxide, is disposed on the structural layer 110. The structural layer 110 is a low stress silicon nitride (Si₃N₄) . The stress of the silicon nitride (Si₃N₄) is approximately 100 to 200 MPa.

Note that embodiments of the invention are not limited to thermal fluid injection devices. Other types of fluid injection devices, such as piezoelectric fluid injectors can employ sensors measuring the thickness of a deformable layer are within the scope and spirit of the invention.

First Embodiment

During fabrication of the injection device 10, steps of etching substrate wafer 100 or sacrificial layer (not shown) are provided. The etching steps comprise wet etching using an etching solution such as an acid solution (49% HF) or an alkaline solution (30% KOH). The structural layer 110 is used as etch stop layer.

The structural layer 110 can be low stress silicon nitride, preferably with tensile stress of about 100 MPa, formed by low pressure chemical vapor deposition (LPCVD). If over-etched, the structural layer 110 can be too thin (<0.4 μm), causing cracks and damaging a signal transmitting circuit thereon. It is appreciated that different thicknesses of the structural layer can cause different driving conditions including heating time and driving voltage. Eventually, the thickness of the structural layer dominates both the yield rate and performance of fluid injection devices

FIG. 2B is schematic view of a sensor 150 of the fluid injector 100 as shown in FIG. 2A, wherein only a part is shown. The sensor 150 comprises a capacitor 160 in series with a resistor 170 to form an R-C circuit. The capacitor 160 may comprise an upper electrode 164 and a lower electrode 162 formed by metal and polysilicon separately. The upper electrode 164 and the resistor can further couple to the signal transmitting circuit.

FIG. 2C is an equivalent R-C series circuit of the sensor 150 shown in FIG. 2B. The relationship between capacitance and electrode area is C=ε·A/d and the output voltage of the equivalent R-C series circuit is V=V₀(1−e^{-t/RC}), where A is the electrode area, ε is the dielectric constant of structural layer, d is the thickness of the structural layer, and R is the resistance value. When the output voltage is known, the thickness d of the structural layer can thus be calculated by the aforementioned relationship.

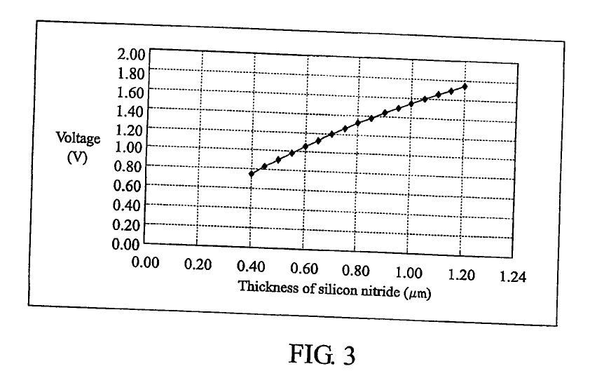

FIG. 3 is a curve showing the relationship between output voltage and thickness of the structural layer of equivalent R-C series circuits. The simulation results are shown in Table 1, when applied voltage V₀=3V, electrode area A=200 μm×200 μm, series resistance R=30 kΩ, dielectric constant of the structural layer (silicon nitride) ε=5.75×10⁵F/μm, and charging time t=50 ns.

TABLE 1

| Thickness of structural layer (μm) | Output voltage (Volt) |
|---|---|
| 0.6 | 1.06 |
| 0.8 | 1.32 |
| 1.0 | 1.55 |
| 1.2 | 1.74 |

Note that the sensor can be formed simultaneously with the metal or polysilicon deposition prosesses, without adding production cost or deteriorating production yield. Using a sensor to measure thickness of the structural layer can be advantageous over optical methods for preventing structural layer overetching.

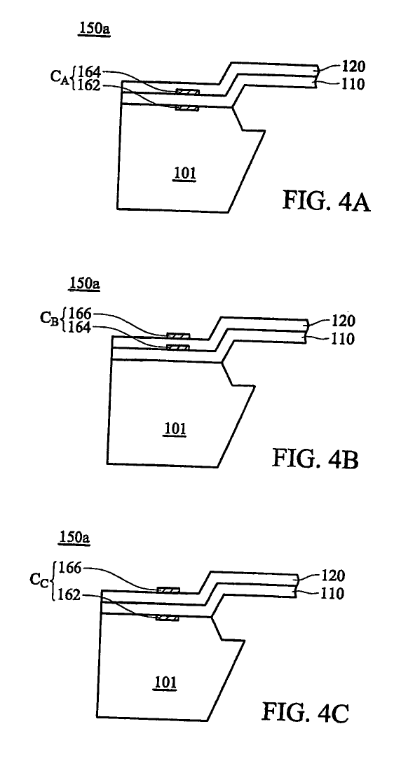

FIGS. 4A-4C are schematic views of exemplary embodiments of the capacitors of the injection device shown in FIG. 2A. It is appreciated that capacitors can be divided into C_{A}, C_{B}, and C_{C} according to dielectric layers. Referring FIG. 4A, a first capacitor C_{A} comprises a first electrode 162, a second electrode 164, and a dielectric layer 110 therebetween. Similarly, the relationship between capacitance and electrode area is C_{A}=ε_{SiN}·A/d_{SiN} and the output voltage of the equivalent R-C series circuit is V=V₀(1−e^{t/RC}^{_{A}}), where A is the electrode area, ε_{SiN} is the dielectric constant of the structural layer, and d_{SiN} is the thickness of the structural layer. If V, V₀, A, R and ε_{SiN} are known, the thickness d_{SiN} of the structural layer 110 can thus be calculated by the aforementioned relationship.

Referring FIG. 4B, a second capacitor C_{B} comprises a second electrode 164, a third electrode 166 and a dielectric layer 120 therebetween. Similarly, the relationship between capacitance and electrode area is C_{B}=ε_{SiO}_{₂}·A/d_{SiO}_{₂} and the output voltage of the equivalent R-C series circuit is V=V₀(1−e^{-t/RC}^{_{B}}), where A is the electrode area, ε_{SiO2} is the dielectric constant of the structural layer, and d_{SiO2} is the thickness of the passivation layer. If V, V₀, A, R and ε_{SiO2} are known, the thickness d_{SiO2} of the passivation layer 120 can thus be calculated by the aforementioned relationship.

Referring FIG. 4C, a first capacitor C_{C} comprises a first electrode 162, a third electrode 166, and dielectric layers 110, 120 therebetween. Similarly, the relationship between capacitance and electrode area is C_{C}=ε_{SiN+SiO}^{²}·A/d_{SiN+SiO}^{²} and the output voltage of the equivalent R-C series circuit is V=V₀(1−e^{-t/RC}^{_{C}}), where A is the electrode area, ε_{SiN+SiO2} is the equivalent dielectric constant of composite layers 110, 120, and d_{SiN+SiO2} is the thickness of the composite layers 110, 120. If V, V₀, A, R and ε_{SiN+SiO2} are known, the thickness d_{SiN+SiO2} of the dielectric layers 110, 120 can thus be calculated by the aforementioned relationship.

Note that thickness of the dielectric layers can only be calculated when the dielectric constant ε is known. In some embodiments, when the dielectric constant ε of the structural layer is unknown, three capacitance equations are required to calculate the thickness of the structural layer. For example, if each capacitance is measured separately C_{A}=2.88 pF, C_{B}=2.42 pF, and C_{C}=1.31 pF, and electrode area A=200 μm×200 μm, dielectric constant of passivation layer 120 ε_{SiO2}=4.1ε₀=36.3 pF/m (ε₀=8.85 pF/m), thickness of the structural layer, thickness of the passivation layer, and dielectric constant of the structural layer can therefore be calculated as d_{SiN}=0.8 μm d_{SiO2}=0.6 μm, and ε_{SiN}=57.5 pF/m.

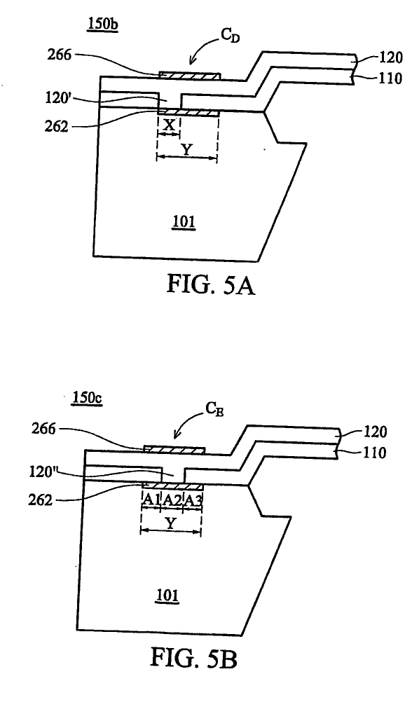

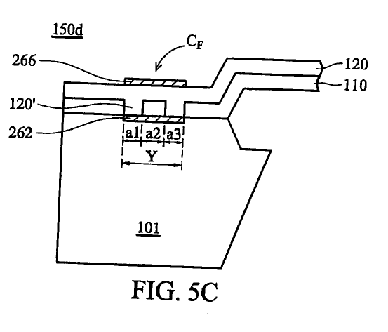

FIGS. 5A-5C are schematic views of embodiments of the capacitors of the injection device shown in FIG. 2A. The dielectric layers between the upper and the lower electrodes can be composite materials. Referring to FIG. 5A, an opening 120′ can be formed by patterning the structural layer 110. The passivation layer 120 is formed on the structural layer 110 filling opening 120′. The capacitor C_{D} is therefore divided into two areas X, and Y-X. Capacitor C_{D} can be expressed as:

$${C}_{D} = A [ \frac{{ɛ}_{SiO2}}{X ( {d}_{SiO2} + {d}_{SiN} )} + \frac{{ɛ}_{SiO2} {ɛ}_{SiN}}{Y ( {d}_{SiN} {ɛ}_{SiO2} + {d}_{SiO2} {ɛ}_{SiN} )} ] ,$$

where A is the area of capacitor C_{D}, X, Y are capacitor regions with different dielectric constant separately. When Y:X=2:1, the area of silicon oxide 120, 120′ (X) equals the area of composite of silicon nitride 110 and silicon oxide 120. If capacitance C_{D} is measured, and electrode area is known, thickness of the structural layer d_{SiN}, thickness of the structural layer d_{SiO2}, dielectric constant of the structural layer ε_{SiN} and dielectric constant of the structural layer ε_{SiO2} can be calculated. Similarly, in FIG. 5B, an opening 120″ can be formed by patterning the structural layer 110. The passivation layer 120 is formed on the structural layer 110 filling opening 120″. The capacitor C_{E} is therefore divided into three areas A₁, A₂, and A₃. The thickness of the structural layer d_{SiN}, thickness of the structural layer d_{SiO2}, dielectric constant of the structural layer ε_{SiN} and dielectric constant of the structural layer ε_{SiO2} can therefore be calculated, when capacitor C_{E} is known. Similarly, in FIG. 5C, two openings 120′ can be formed by patterning the structural layer 110. The passivation layer 120 is formed on the structural layer 110 filling openings 120′. The capacitor C_{F} is therefore divided into three areas a₁, a₂, and a₃. The thickness of the structural layer d_{SiN}, thickness of the structural layer d_{SiO2}, dielectric constant of the structural layer ε_{SiN} and dielectric constant of the structural layer ε_{SiO2} can therefore be calculated, when capacitor C_{F} is known.

Second Embodiment

Another embodiment of the invention provides a method of controlling injection quality for a fluid injector. The fluid injector comprises a structural layer and at least one fluid actuator, and a sensor on the structural layer. The fluid actuator such as heater generates heat conducting through the structural layer to the fluid chamber. Since the thermal flux J is inversely proportional to distance L, as the same material with the same thermal conduction coefficient k, i.e., J=−k/L. Under the same driving conduction, thickness variations of the structural layer can cause instability of injection.

In order to maintain the same turn-on energy for droplet firing of each injector, the thicker the structural layer, the longer the required heating time. When the uniformity of the structural layer is uneven, adjustment of the heating time according to thickness variation of the structural layer is required.

The thickness of the structural layer can be measured using a sensor. The sensor comprises a capacitor with an upper electrode, a lower electrode, and the structural layer therebetween. The relationship between capacitance and electrode area is C=ε·A/d and the output voltage of the equivalent R-C series circuit is V=V₀(1−e^{-t/RC}), where A is the electrode area, ε is the dielectric constant of the structural layer. When the output voltage is known, the thickness d of the structural layer can thus be calculated by aforementioned relationship.

Referring to FIG. 3 again, when applied voltage V₀=3V, electrode area A=200 μm×200 μm, series resistance R=30 kΩ, dielectric constant of the structural layer (silicon nitride) ε=5.75×10⁵F/μm, and charging time t=50 ns, the simulation results are shown in Table 1.

In practice, relationships between the structural layer and the driving condition can be established and stored in a built-in database. The thickness of the structural layer is measured by the sensor, thereby outputting an analog signal to digital (A/D) converter connecting the sensor. The analog signal is converted by the A/D converter into a digital signal. The digital signal is then compared with the built-in database, thereby outputting an adjusted signal to the controller. The fluid actuator according is driven to the adjusted signal to maintain injection quality.

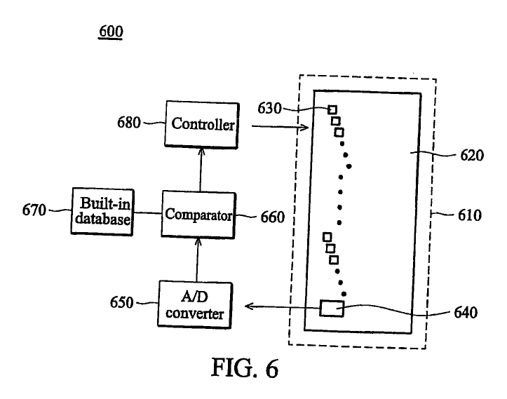

FIG. 6 is a block diagram of an exemplary embodiment of a fluid injection device 600 according to the invention. The fluid injection device 600 comprises an injector 610 with structural layer 620, a plurality of heaters 630, and sensor 640. The cross section of the fluid injector device 600 is shown in FIG. 2A. An analog to digital (A/D) converter 650 connects the sensor 640. The A/D converter 650 can convert an analog signal from the sensor 640 measuring the thickness of the structural layer 620 into a digital signal. A comparator 660 compares the digital signal with a built-in database 670, thereby outputting an adjusted signal. A controller 680 can drive the fluid actuator according to the adjusted signal.

The invention also provides a method of controlling injection quality for a fluid injector 610. The fluid injector 610 comprises a structural layer 620 and at least one fluid actuator 630, and a sensor 640 on the structural layer. The method comprises the steps of measuring the thickness of the structural layer 620 by the sensor 640, thereby outputting an analog signal. The A/D converter 650 can convert an analog signal from the sensor 640 measuring the thickness of the structural layer 620 into a digital signal. A comparator 660 compares the digital signal with a built-in database 670, thereby outputting an adjusted signal. And the adjusted signal is received to drive the at least one fluid actuator 630.

The thickness or the dielectric constant of the structural layer of each injection device can be measured by sensors, thereby the thickness of the structural layer of each injection device can be more precisely controlled. During injection, moreover, the results of thickness or dielectric constant of the structural layer of each injection device can be used in accordance with driving conditions.

The physical properties, such as thickness and dielectric constant of the structural layer can be calculated by output of the sensor. Fluid injectors and methods of controlling injection quality for fluid injectors are not limited to inkjet printers, other applications, such as fuel injectors, biomedical chips, are also applicable.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A fluid injection device, comprising:
a fluid chamber for receiving fluid with a first layer thereon;
at least one fluid actuator positioned on the first layer;
a sensor for measuring the thickness of the first layer;
a second layer disposed on the first layer covering the at least one fluid actuator and the sensor; and
a nozzle adjacent to the fluid actuator and communicating with the fluid chamber through the second layer and the first layer.

2. The device as claimed in claim 1, wherein the fluid actuator comprises resistive heaters.

3. The device as claimed in claim 2, wherein the resistive heaters comprise:
a first heater disposed on the structural layer outside the fluid chamber to generate a first bubble in the fluid chamber; and
a second heater disposed on the structural layer outside the fluid chamber to generate a second bubble in the fluid chamber.

4. The device as claimed in claim 1, wherein the first layer is low stress silicon nitride.

5. The device as claimed in claim 1, wherein the sensor comprises at least one capacitor.

6. The device as claimed in claim 5, further comprising a resistor in series with the at least one capacitor.

7. The device as claimed in claim 5, wherein the capacitor comprises a plurality of capacitive units parallel with each other.

8. The device as claimed in claim 7, wherein the capacitances of each capacitive unit are different.

9. The device as claimed in claim 1, wherein the sensor connects to an analog to digital converter.

10. The device as claimed in claim 1, further comprising a fluid channel connecting the fluid chamber.

11. The device as claimed in claim 1, further comprising:
an analog to digital (A/D) converter connecting the sensor, the A/D converter converting an analog signal from the sensor measuring the thickness of the first layer into a digital signal;
a comparator comparing the digital signal with a built-in database, thereby outputting an adjusted signal; and
a controller for driving the at least one fluid actuator according to the adjusted signal.

12. A method of controlling injection quality for a fluid injector, the fluid injector comprising a structural layer and at least one fluid actuator, and a sensor on the structural layer, comprising the steps of:
measuring physical properties of the structural layer by the sensor, thereby outputting a control signal; and
receiving the control signal to drive the at least one fluid actuator.

13. The method as claimed in claim 12, wherein the physical properties comprise thickness and dielectric constant of the structural layer.

14. The method as claimed in claim 12, wherein the sensor comprises at least one capacitor.

15. The method as claimed in claim 14, wherein the capacitor comprises a plurality of capacitive units parallel with each other.

16. The method as claimed in claim 15, wherein the capacitances of each capacitive unit are different.

17. The method as claimed in claim 12, further comprising a resistor in series with the at least one capacitor.
